(19) United States
(12) Patent Application Publication
(10) Pub. No.: US 2023/0167341 A1
(43) Pub. Date: Jun. 1, 2023

(54) SOLVENT-BASED LAMINATING ADHESIVE

(71) Applicants: Dow Global Technologies LLC, Midland, MI (US); Rohm and Haas Company, Collegeville, PA (US)

(72) Inventors: Jie Wu, Lake Jackson, TX (US); Joseph J. Zupancic, Glen Ellyn, IL (US); Kalyan Sehanobish, Sanford, MI (US)

(21) Appl. No.: 17/997,681

(22) PCT Filed: Apr. 23, 2021
(86) PCT No.: PCT/US2021/028750

§ 371 Date: Nov. 1, 2022

Related U.S. Application Data
(60) Provisional application No. 63/033,862, filed on Jun. 3, 2020.

(51) Int. Cl. C09J 175/06; B32B 7/12

(52) U.S. Cl. CPC C09J 175/06; B32B 7/12; B32B 2307/7244; B32B 2439/00; B32B 2255/26

(57) ABSTRACT

A two-component, solvent-based polyurethane adhesive composition based on a crystalline polyester-polycarbonate for producing an adhesive laminate structure including: (a) at least one isocyanate component; and (b) at least one isocyanate-reactive component comprising at least one crystalline polyester-polycarbonate compound; and a process for preparing the adhesive composition.

### FIELD

The present invention relates to a solvent-based laminating adhesive composition; and to a process of preparing such laminating adhesive composition.

### BACKGROUND

Laminating adhesives are used to bond different substrates together. A common usage of such bonded substrates is in flexible food packaging applications. The laminating adhesive is typically applied to the surfaces of two polymeric substrate layers to form a bonding layer in between the two substrate layers. The adhesive forms a bonding layer inbetween the substrate layers to provide a strong bond between the two substrate layers. The adhesive-bonded substrates structure helps keep the packaging structure intact; and the food inside the packaging structure safe and secure. A growing demand in the flexible food packaging industry is for a laminating adhesive with good gas barrier properties such as to reduce oxygen permeability through the layered structure of the flexible food packaging. Laminating adhesives that are used to produce a layered food package structure exhibiting a reduced oxygen permeability could potentially simplify packaging structures, reduce cost-in-use, and make the food package recyclable. It is therefore desirous to provide a laminating adhesive with enhanced oxygen barrier performance such as an adhesive demonstrating a low oxygen permeability compared to standard adhesive. In particular, it is desirous to provide a laminating adhesive based on crystalline polyester-polycarbonate compounds such that the adhesive has a gas barrier effect/property.

### SUMMARY

An objective of the present invention is to provide a laminating adhesive useful for flexible packaging applications, wherein the laminating adhesive has an enhanced oxygen barrier performance compared to standard adhesives; and a process for producing such laminating adhesive.

In one embodiment, the present invention is directed to a two-component, solvent-based polyurethane adhesive composition, wherein the adhesive composition is based on a crystalline polyester-polycarbonate and wherein the adhesive composition is useful for producing an adhesive laminate structure. The adhesive composition includes, for example: (a) at least one isocyanate component; and (b) at least one isocyanate-reactive component comprising at least one crystalline polyester-polycarbonate compound.

In another embodiment, the present invention is directed to a process for preparing the above adhesive composition.

In still another embodiment, the present invention is directed to a multi-layer laminate product including: (A) at least a first layer; (B) at least a second layer; and (C) at least one layer of the above adhesive composition disposed inbetween the first layer and the second layer; and wherein the adhesive composition is cured to bond the first layer to the second layer.

In yet another embodiment, the present invention is directed to a process for producing the above multi-layer laminate product.

In even still another embodiment, the present invention is directed to a packing product produced using the above multi-layer laminate product.

### DETAILED DESCRIPTION

As used throughout this specification, the abbreviations given below have the following meanings, unless the context clearly indicates otherwise: “<” means “less than”; “>” means “greater than”; “<” means “less than or equal to”; >” means “greater than or equal to”; “@” means “at”; μm=micron(s), g=gram(s); mg=milligram(s); L=liter(s); g/cc=gram(s) per cubic centimeter; mL=milliliter(s); g/mL=gram(s) per milliliter; g/mol=gram(s) per mole; g/m²=gram(s) per square meter; ppm=parts per million; ppmw=parts per million by weight; rpm=revolutions per minute; m=meter(s); mm=millimeter(s); cm=centimeter(s); cm/min=centimeter(s) per minute; min=minute(s); s=second(s); hr=hour(s); ° C.=degree(s) Celsius; N=Newtons; mmHg=millimeters of mercury; psig=pounds per square inch; ccO₂/m²/day=cubic centimeters of oxygen per [square meter−day]; N/15 mm=Newton(s) per 15 millimeters; kPa=kilopascal(s); %=percent, vol %=volume percent; and wt %=weight percent.

Unless stated otherwise, all percentages, parts, ratios, and like amounts, are defined by weight. For example, all percentages stated herein are weight percentages (wt %), unless otherwise indicated.

Temperatures are in degrees Celsius (° C.); and “ambient temperature” and/or “room temperature” means a temperature between 20° C. and 25° C., unless specified otherwise.

The present invention is directed to a novel two-component, solvent-based polyurethane adhesive composition, wherein the adhesive composition is based on a crystalline polyester-polycarbonate and wherein the adhesive composition is useful for producing an adhesive laminate structure. In one broad embodiment, the adhesive composition of the present invention includes: (a) at least one isocyanate component; and (b) at least one isocyanate-reactive component comprising at least one crystalline polyester-polycarbonate compound.

To prepare the two-part adhesive composition includes providing a first part comprising an isocyanate component, component (a); providing a second part comprising a polyol component, component (b); and then combining or mixing component (a) and component (b) to form the two-part adhesive system or composition.

The isocyanate component, component (a), of the present invention can include one or more isocyanate compounds. For example, the isocyanate compound can include aliphatic-based isocyanates, aromatic-based isocyanates, and mixtures thereof. An aliphatic-based polyisocyanate is an isocyanate that contains no aromatic rings. Examples of suitable aliphatic isocyanates useful in the present invention include, but are not limited to, hexamethylene diisocyanate (HDI); diisocyanatodicyclohexylmethane (H₁₂MDI); xylylene diisocyanate (XDI); 1,4- or 1,3-bis(isocyanatomethyl)cyclohexane (H₆XDI); tetramethylxylylene diisocyanate; dimers, trimers, derivatives and mixtures of two or more thereof.

The aromatic-based isocyanate useful in the present invention can include, for example, one or more polyisocyanate compounds including, but are not limited to, for example 1,3- and 1,4-phenylene diisocyanate; 1,5-naphthylene diisocyanate; 2,6-toluene diisocyanate (2,6-TDI); 2,4-toluene diisocyanate (2,4-TDI); 2,4′-diphenylmethane diisocyanate (2,4′-MDI); 4,4′-diphenylmethane diisocyanate (4,4′-MDI); polymeric isocyanates; and mixtures of two or more thereof.

In one preferred embodiment, the isocyanate component useful in the present invention can be XDI based polyisocyanate; HDI-based polyisocyanate; MDI based polyisocyanate; TDI-based polyisocyanate; and mixtures thereof.

Exemplary of some commercial isocyanate components useful in the present invention can include TAKENATE® D-110N and TAKENATE® D-120N (both available from Mitsui Chemical); DESMODUR® N 3300, DESMODUR® Quix 175, and DESMODUR® E 2200/76 (all available from The Covestro Company; and ISONATE™ 125 M, ADCOTE™ L76-204, COREACTANT CT, and CATALYST F (all available from The Dow Chemical Company); and mixtures thereof.

The isocyanate has an average functionality of greater than 2 isocyanate groups/molecules. In one embodiment, for instance, the isocyanate may have an average functionality of from 2.1 to 4.0.

A compound having isocyanate groups, such as the isocyanate component (a) of the present invention, can also be characterized by a weight percentage of isocyanate groups (NCO) based on a total weight of the compound. The weight percentage of isocyanate groups is termed “% NCO” and is measured in accordance with ASTM D2572-97. In one embodiment, the NCO content of component (a) is 7% or more; and 10% or more in another embodiment. In still another embodiment, the NCO content of component (a) is 30% or less; and 25% or less in yet another embodiment.

The amount of the isocyanate component used in the present invention process is, for example, from 2 wt. % to 40 wt. % in one embodiment, from 3 wt. % to 30 wt. % in another embodiment and from 4 wt. % to 20 wt. % in still another embodiment.

The isocyanate-reactive component, component (b) (or the B-side component) of the present invention, includes an isocyanate-reactive composition which is at least one crystalline polyester-polycarbonate compound. In a preferred embodiment, the at least one crystalline polyester-polycarbonate compound can include other compounds to form the isocyanate-reactive composition. For example, the isocyanate-reactive composition can be a mixture, combination or blend of: (b1) a predetermined amount of the at least one crystalline polyester-polycarbonate compound; (b2) a predetermined amount of at least one acrylic polymer compound; and (b3) a predetermined amount of at least one solvent. The blend or mixture of the above three components (b1)-(b3) forms the isocyanate-reactive component (b) that is mixed with the isocyanate component (a). The polyurethane adhesive composition based on a crystalline polyester-polycarbonate for producing an adhesive laminate structure is formed by mixing component (a) with component (b).

Component (a) can be mixed with component (b) at a weight ratio of from 4:100 to 30:100 in one embodiment; from 5:100 to 25:100 in another embodiment; and from 6:100 to 20:100 in still another embodiment.

A crystalline polyester-polycarbonate diol is a compound that has the structure of polyester functionality, polycarbonate functionality and hydroxyl terminated groups; and is solid over the temperature range that includes the range of 10° C. to 40° C. Generally, the polyester-polycarbonate diol of the present invention is the reaction product of: (bi) at least one polyester polyol precursor; and (bii) at least one polycarbonate polyol precursor. For example, the polyester polyol precursor may be selected from the group consisting of polyester resins based on ethylene glycol, diethylene glycol, 1,4- butanediol, 1,6-hexanediol, adipic acid, azelaic acid, sebacic acid, terephthalic acid, and combinations thereof. For example, a polycarbonate polyol precursor may be selected from the group consisting of polycarbonate resins based on ethylene glycol, diethylene glycol, 1,4-butanediol, 1,6-hexanediol, 1,4-cyclohexanedimentanol, alkylene carbonates, diaryl carbonates, dialkyl carbonate, and combinations thereof.

Examples of suitable crystalline polyester-polycarbonate diol useful in the present invention include, but are not limited to, (1) the reaction product of poly(1,4-butanediol-adipic acid) and poly(1,4-butanediol-dimethyl carbonate); (2) the reaction product of poly(1,6-hexanediol-adipic acid) and poly(1,4-butanediol-dimethyl carbonate); and (3) mixtures of two or more thereof. A preferred crystalline polyester-polycarbonate diol useful in the present invention is a crystalline polyester-polycarbonate diol having a melting temperature of from 35° C. to 60° C. and a molecular weight of from 500 g/mol to 3,500 g/mol.

Exemplary of some of commercial polyester diol compounds useful in the present invention can include, for example, BESTER™ 86 (available from The Dow Chemical Company); STEPANPOL®PC-105P-110, STEPANPOL®PC-102P-110, and STEPANPOL® PC-205P-056 (all available from Stepan Company); and mixtures thereof.

Exemplary of some of commercial polycarbonate diol compounds useful in the present invention can include, for example, ETERNACOLL®UH-100, ERNACOLL®UH-200 and ETERNACOLL®UH-300 (all available from UBE Industries, Inc.).

The amount of the crystalline polyester-polycarbonate compound, component (b), used in the present invention is, for example, from 10 wt % to 50 wt % in one embodiment, from 15 wt % to 45 wt % in another embodiment and from 20 wt % to 40 wt % in still another embodiment.

As aforementioned, one preferred embodiment of the present invention includes an isocyanate-reactive composition mixture, combination or blend of: (bi) a predetermined amount of the at least one crystalline polyester-polycarbonate compound; (bii) a predetermined amount of at least one acrylic polymer compound; and (biii) a predetermined amount of at least one solvent.

The at least one crystalline polyester-polycarbonate compound, component (bi), useful for forming the isocyanate-reactive composition blend is described above.

The at least one acrylic polymer compound, component (bii), useful in the present invention is a flow modifier or a flow control agent which are typically used in powder coatings to control cratering and reduce orange-peel characteristics. Flow modifiers help control interfacial tension and surface tension of the adhesives.

The flow modifier useful in the present invention can include one or more common flow modifiers. Examples of the flow modifier include low glass transition temperature acrylics such as polylauryl acrylate, polybutyl acrylate, poly(2-ethylhexyl) acrylate, poly(ethylacrylate-2-ethylhexylacrylate), polylauryl methacrylate, and acrylic copolymers made of two or more monomers including methyl acrylate, ethyl acrylate, butyl acrylate, 2-ethylhexyl acrylate, lauryl acrylate, methyl methacrylate, acrylic acid, methacrylic acid, styrene, vinyl acetate, butadiene and the like; and mixtures thereof. Other flow modifiers useful in the present invention can include silicon-containing polymers and fluorinated polymers, such as the esters of polyethylene glycol, esters of polypropylene glycol, fluorinated fatty acids, and mixtures thereof.

The amount of the acrylic polymer compound used to make isocyanate-reactive co-reactant, component (b), of the present invention process is, for example, from 0.05 wt % to 4 wt % in one embodiment, from 0.1 wt % to 3 wt % in another embodiment and from 0.2 wt % to 2 wt % in still another embodiment.

The at least one solvent compound, component (biii), of the present invention can include one or more compounds including, for example, ethyl acetate, methyl ethyl ketone, propyl acetate, toluene, and mixtures thereof. Other conventional solvents known to those skilled in the art can also be used. In one preferred embodiment, the solvent compound useful in the present invention can include, for example, ethyl acetate, methyl ethyl ketone, and mixtures thereof.

The amount of the solvent compound used to make the isocyanate-reactive co-reactant, component (b), of the present invention is, for example, from 10 wt % to 90 wt % in one embodiment, from 30 wt % to 85 wt % in another embodiment and from 50wt % to 80 wt % in still another embodiment

In some embodiments, the adhesive composition of the present invention can include one or more optional additives including but are not limited to, for example, tackifiers, catalysts plasticizers, rheology modifiers, adhesion promoters, antioxidants, fillers, colorants, surfactants, solvents, and combinations of two or more thereof.

The amount of the optional components useful in the adhesive composition can be, for example, from 0 wt % to 3 wt % in one embodiment, from 0 wt % to 2 wt % in another embodiment and from 0.01 wt % to 1 wt % in still another embodiment.

In general, the process of making the laminating adhesive composition includes the steps of: (I) synthesizing a crystalline polyester-polycarbonate diol by reacting at least one polyester polyol and at least one polycarbonate polyol at a temperature of from 180° C. to 250° C. for a period of time of from at least 2 hr to 8 hr; (II) melting the crystalline polyester-polycarbonate diol from step (I) (the crystalline polyester-polycarbonate diol is a solid at a temperature of from 15° C. to 40° C.), at a temperature of from 50° C. to 70° C.; (III) pouring the melted diol from step (II) into a reactor, where the reactor has been preheated at a temperature of from 50° C. to 60° C.; (II) loading the solvent and any other optional additives into the reactor; (IV) mixing all components in the reactor with agitation until a resultant uniformly mixed, fully clear solution is formed; and (V) removing the resulting fully clear solution from the reactor.

A multi-layer laminate product can be formed including a layer of the solvent-based polyurethane adhesive composition based on a crystalline polyester-polycarbonate of the present invention. Any number of layers can be used to form the laminate product. In one preferred embodiment, the laminate is formed by the steps of: applying the adhesive composition to at least one of two substrate layers (e.g., the substrates can be made of the same material or of different materials); combining the substrates together such that the adhesive composition is disposed as a layer between the surfaces of the two substrates; and then curing the adhesive composition to form a bonding layer between the two substrates. In general, each of the two substrates can include, for example, two separate polymer films. As used herein, a “film” is any layer structure that is 0.5 mm or less in one dimension of the layer structure; and is 1 cm or more in both of the other two dimensions of the layer structure. A “polymer film” is a film that is made of a polymer or mixture of polymers. The composition of a polymer film is, typically, 80 percent by weight or more of one or more polymers.

Suitable substrates used to form the laminate structure include films such as paper, woven and nonwoven fabric, polymer films, metal-coated (metallized) polymer films, and combinations thereof. The substrates are layered to form a laminate structure, with an adhesive composition according to the present invention adhering one or more of the substrates together.

In a preferred embodiment, the multi-layer laminate product prepared using the adhesive composition of the present invention includes: (A) at least a first layer; (B) at least a second layer; and (C) at least one layer of the adhesive composition disposed inbetween the first layer and the second layer; wherein the adhesive is cured to bond the first layer to the second layer.

In one general embodiment, the multi-layer laminate product can be two or more film substrates or film layers combined together with the adhesive composition. In some embodiments, the laminate product is a laminate film structure including a first film layer, a second film layer, and a barrier adhesive layer disposed intermediate the first film layer and the second film layer. For example, in a preferred embodiment, the multi-layer laminate product can be made of three layers including the first film layer (or outer layer), the second film layer (or inner layer) and a bonding layer comprising the adhesive composition disposed inbetween the first and second layers.

The 3-layer laminate product of the present invention can have a layered structure of A/B/A wherein A represents the first and second layers being of the same material and wherein

B represents the bonding layer of adhesive composition. Although a 3-layer laminate film product is referenced herein, the present invention includes a multi-layer laminate member with any number of film layers provided at least one layer of the multi-layer film member is the bonding layer of adhesive composition, where the bonding layer has the proper gas barrier properties. As aforementioned, the structure of the multi-layer film member can be A/B/A wherein both layers represented by A is made of the same polymer material; or the structure of the multi-layer film member can be A/B/C wherein C represents a film layer than is made of a different material than the layer of A. Or, the structure of the multi-layer film member can be any combination of A, B, and C layers which are apparent to one skilled in the art of laminate making.

The first layer of the present invention laminate product can be made of one or more materials, including, for example, polyethylene, polypropylene, polyethylene terephthalate, polyamide, polystyrene, cycloolefin copolymer, polyvinyl chloride, styrene butadiene, and the like. In one preferred embodiment, the material of the first layer useful in the present invention can be polypropylene, polyethylene, and combinations thereof. Exemplary of some of the commercial materials useful in the first layer of the present invention can include, for example, biaxial oriented polypropylene (available from FILMTECH, INC.); and polyethylene (available from Berry Plastics); and mixtures thereof. In another preferred embodiment, the first film layer can be made of, for example, polypropylene having a density of from 0.89 g/cc to 0.92 g/cc.

The thickness of the first layer used in the present invention laminate product is, for example, from 10 μm to 200 μm in one embodiment, from 15 μm to 150 μm in another embodiment and from 20 μm to 125 μm in still another embodiment.

As aforementioned, the second layer of the present invention laminate product can be made of the same material as the first layer which has the advantage of being more easily recyclable. In another embodiment, the second layer can be made of one or more materials different from the first layer.

When the second layer of the laminate product is made of a different polymer from the first layer, the second layer can include, for example, polyethylene, polypropylene, polyethylene terephthalate, polyamide, polystyrene, cycloolefin copolymer, polyvinyl chloride, styrene butadiene, and mixtures thereof. In one preferred embodiment, the material of the second layer useful in the present invention can be polyethylene, polypropylene, and mixtures thereof. Exemplary of some of the commercial materials useful in the second layer of the present invention can include, for example, polyethylene (available from Berry Plastics); and biaxial oriented polypropylene (available from FILMTECH, INC.); and mixtures thereof. In another preferred embodiment, the second film layer, when different from the first layer, can be made of, for example, polyethylene having a density of from 0.915 g/cc to 0.967 g/cc.

The thickness of the second layer used in the present invention film is, for example, from 10 μm to 200 μm in one embodiment, from 15 μm to 150 μm in another embodiment and from 20 μm to 125 μm in still another embodiment.

In general, one process for producing a multi-layer laminate product as described above includes the steps of:

(I) applying the adhesive composition of the present invention to at least a portion of the surface of a first layer and/or a second layer;

(II) contacting the first layer and the second layer such that the adhesive is disposed inbetween the first layer and the second layer; and

(III) curing the adhesive to form a multi-layer laminate product comprising the first layer bonded to the second layer via the cured adhesive.

The laminate film structure of the present invention includes films made from polymers bonded together using a barrier adhesive composition in place of a standard adhesive composition, while the laminate film structure of the present invention still achieves similar or enhanced barrier properties. One of the advantageous properties exhibited by the laminate product made by the above process of the present invention can include, for example, a laminate having an improved (i.e., a reduced) oxygen transmission rate (OTR). In some embodiments, the laminate film structure has an OTR not greater than 750 cubic centimeters of oxygen per [square meter−day] abbreviated as “ccO₂/m²/day” and measured according to ASTM Method D3985.

Because a laminate film structure can be designed with various layer materials, number of layers, film thicknesses and other properties, the OTR of a particular laminate structure will depend on, for example, the various properties of the first and second layers. As an illustration, and not to be limited thereby, the OTR of the laminate structure of the present invention is generally 15% less than a laminate using a standard adhesive composition in one embodiment, 25% less than a laminate using a standard adhesive composition in another embodiment, and 50% less than a laminate using a standard adhesive composition in still another embodiment. In yet another embodiment, the OTR of the laminate structure of the present invention is from 10% to 95% less than a laminate using a standard adhesive composition.

The laminate prepared as described above can be used, for example, in flexible packaging applications; and in home and personal care applications. In one preferred embodiment, the laminate is used to make a multi-layer laminate structure product or article such as a package, pouch or container for packaging food. In a preferred embodiment, the laminate is made of two layers of polymeric film with an adhesive layer disposed inbetween the two film layers bonding the two polymer films together. The process of making an article such as a food packaging article can be carried out by those skilled in the art of food packaging manufacturing.

As described above, there is a reduction in the permeability of oxygen through the laminate structures by using the barrier adhesive layer of the present invention in place of standard adhesives; and therefore, the article which is made using the laminate described above will have the same advantageous gas barrier properties such as an improved (i.e., a reduced) OTR as exhibited by the laminate described above.

In addition, a multi-layer laminate having an ABA structure can advantageously be a simple, readily manufacturable structure and can also beneficially be recyclable such that the food packaging made from the laminate is environmentally friendly.

### EXAMPLES

The following examples are presented to further illustrate the present invention in detail but are not to be construed as limiting the scope of the claims. Unless otherwise indicated, all parts and percentages are by weight.

Various materials or ingredients used in the Inventive Examples (Inv. Ex.) and the Comparative Examples (Comp. Ex.) are explained as follows:

MOR-FREE™ C33 is an aliphatic based isocyanate and is available from The Dow Chemical Company (Dow).

ADCOTE™ 577 is an isocyanate-terminated compound and is available from Dow.

ADCOTE™ 577B is a hydroxyl-terminated compound and is available from Dow.

BESTER™ 86 is a poly(butanediol-adipate) having a molecular weight (Mw) of 1,000, a melting point of about 50° C., and an OHN of 112; and is available from Dow.

MODAFLOW® is an acrylic copolymer resin useful as a flow modifier and is available from Allnex Inc.

DOWTHERM™ is a heat transfer fluid and is available from Dow.

TYZOR® TPT (tetra-isopropyl titanate) is a highly reactive organic alkoxy titanate with 100% active content, and acts as a Lewis acid catalyst; and is available from Dorf Ketal.

“BOPP” stands for biaxial-oriented polypropylene. BOPP is a film having a thickness of 20 μm and is available from Filmtech Inc.

### Polyester-Polycarbonate Resins

### Synthesis Example 1

### Preparation of 1, 4-Butanediol-Carbonate Resin (“PC-1”)

In this Synthesis Example 1, a 1, 4-btanediol-carbonate resin (herein “PC-1”) having a molecular weight of about 2,000 was prepared using the components described in Table I and using the procedure which follows:

TABLE I
Preparing Polycarbonate Resin (PC-1) (Mw = 2,000)

| Component | | Charge |
|---|---|---|
| No. | Monomer/Intermediate | (g) |
| 1 | 1,4-butanediol | 67,958.0 |
| 2 | dimethyl carbonate | 102,864.0 |
| 3 | TYZOR ® TPT (tetra-isopropyl titanate) | 21.6 |

A 114-liter (L) 316L stainless steel vessel (reactor) was used. The reactor has an internal diameter of 20 inches (50.8 cm) and is equipped with internal baffles, variable speed 12-in (30.5 cm) turbine impeller, sparge ring, closed loop system consisting of a mixed DOWTHERM* system with independent hot and cold loops and a 24-inch (61 cm) packed column. To the reactor, 67,958.0 g butanediol (BDO) were added and heated to 150 degrees Celsius (° C.) while sweeping with nitrogen (N2) to inert the reactor and remove water present in the butane diol. TYZOR® TPT catalyst (21.6 g) was added to the reactor. Dimethyl carbonate (DMC) was also added to the reactor using a flow meter and control valve over a period of 6 hr to 8 hr, maintaining the temperature in the column at 65° C. Upon completion of the DMC addition, the temperature of the reactor was increased to 195° C. and the progress of the reaction in the reactor was tracked by measuring the OH number and 1H-NMR of the reaction mixture for end-group analysis. After 8 hr at 195° C., the OH number of the reaction mixture was found to be 30.7 with 25 percent (%) carbonate end-groups as determined by 1H-NMR; and the temperature of the reactor was decreased to 150° C.; and to the reaction mixture was added 1,860 g of BDO. Then, the temperature of the reaction mixture was brought up to 195° C.; and after an 8 hr reaction, the hydroxyl number of the resultant reaction product was found to be 54 mg KOH/g with<1% carbonate end-groups. The resultant carbonate resin had the following final physical properties: an OHN of 54 and a molecular weight (Mw) of 1,960.

### Synthesis Example 2

### Preparation of 1, 4-Butanediol-Carbonate Resin (herein “PC-2”)

In this Synthesis Example 2, a 1, 4-btanediol-carbonate resin (herein “PC-2”) having a molecular weight of about 1,000 was prepared using the components described in Table II and using the procedure which follows:

TABLE II
Preparing Polycarbonate Resin PC-2

| Component | | Charge |
|---|---|---|
| No. | Monomer/Intermediate | (g) |
| 4 | 1,4-butanediol-carbonate having a Mw of | 1,200 |
| | 2,000 (PC-1 from Synthesis Example 1) | |
| 5 | 1,4-butanediol | 60.5 |

The polycarbonate resin was prepared by charging components 4 and 5 described in Table II to a 2L 4-neck flask equipped with a Teflon stir blade. The resultant mixture in the flask was heated to 210° C. while stirring. Then the stirred mixture was maintained at 210° C. for 4 hr under a nitrogen purge. After 4 hr, the resultant resin had the following final physical properties: an OHN of 112.0 and a Mw of 1,000.

### Polyester-Polycarbonate Resins

### Synthesis Example 3

### Preparation of Polyester-Polycarbonate Polyol 1 (PE-PC-1)

In this Synthesis Example 3, a polyester-carbonate-polyol resin (herein “PE-PC-1”) having a molecular weight of about 1,000 was prepared using the components described in Table III and using the procedure which follows:

TABLE III
Formula to Prepare 1000 MW of Polyester-
Polycarbonate Polyol 1 Resin (PE-PC-1)

| Component | | Charge |
|---|---|---|
| No. | Monomer/Intermediate | (g) |
| 6 | BESTER ™ 86 | 900.0 |
| 7 | 1,4-butanediol-carbonate having a Mw of | 100.0 |
| | 2,000 (PC-1 from Synthesis Example 1) | |
| 8 | 1,4-butanediol | 4.24 |

The PE-PC-1 resin was prepared by charging components 6 through 8 to a 2L 4-neck flask equipped with a Teflon stir blade. The resultant mixture in the flask was heated to 210° C. while stirring and the stirred mixture was maintained at 210° C. for 4 hr under a nitrogen purge. After 4 hr, the resultant resin had the following final physical properties: an OHN of 112.0, a Mw of 1,000, and a melting temperature of 43° C.

### Synthesis Example 4

### Preparation of Polyester-Polycarbonate Polyol 2 Resin (PE-PC-2)

In this Synthesis Example 4, a polyester-carbonate-polyol resin (herein “PE-PC-2”) having a molecular weight of about 1,000 was prepared using the components described in Table IV and using the procedure which follows:

TABLE IV
Formula to Prepare 1,000 MW of Polyester-
Polycarbonate Polyol 2 Resin (PE-PC-2)

| Component | | Charge |
|---|---|---|
| No. | Monomer/Intermediate | (g) |
| 9 | BESTER ™ 86 | 750.0 |
| 10 | 1,4-butanediol-carbonate having a Mw of | 250.0 |
| | 2,000 (PC-1 from Synthesis Example 1) | |
| 11 | 1,4-butanediol | 11.9 |

The PE-PC-2 resin was prepared by charging components 9 through 11 to a 2L 4-neck flask equipped with a Teflon stir blade. The resultant mixture in the flask was heated to 210° C. while stirring. Then, the stirred mixture was maintained at 210° C. for 4 hr under a nitrogen purge. After 4 hr, the resultant resin had the following final physical properties: an OHN of 112.0, a Mw of 1,000, and a melting temperature of 40° C.

### Synthesis Example 5

### Preparation of Polyester-Polycarbonate Polyol 3 (PE-PC-3)

In this Synthesis Example 5, a polyester-carbonate-polyol resin (herein “PE-PC-3”) having a molecular weight of about 1,000 was prepared using the components described in Table V and using the procedure which follows:

TABLE V
Formula to Prepare 1,000 MW of Polyester-
Polycarbonate Polyol 3 Resin (PE-PC-3)

| Component | | Percentage |
|---|---|---|
| No. | Monomer/Intermediate | (wt %) |
| 12 | BESTER ™ 86 | 90 |
| 13 | 1,000 Mw of 1,4-butanediol-carbonate | 10 |
| | (PC-2 from Synthesis Example 2)) | |

The PE-PC-3 resin was prepared by charging components 12 and 13 to a 2L 4-neck flask equipped with a Teflon stir blade. The resultant mixture in the flask was heated to 210° C. while stirring. Then, the stirred mixture was maintained at 210° C. for 4 hr under a nitrogen purge. After 4 hr, the resultant resin had the following final physical properties: an OHN of 112.0, a Mw of 1,000, and a melting temperature of 42° C.

### Isocyanate Co-Reactants

### General Procedure for Preparing an Isocyanate Co-Reactant (CR)

Three isocyanate-reactive co-reactants (CR-1, CR-2, and CR-3) using the compositions described in Table VI are prepared as follows: using a crystalline polyester-polycarbonate polyol compound as described in the above Synthesis Examples 3-5. The polyester-polycarbonate polyol is first melted in an oven at 60° C.; and then the melted crystalline or non-crystalline polyester-polycarbonate polyol compound is mixed with ethyl acetate and Modaflow at 60° C. for 1 hr to form the various isocyanate reactive compositions described in Table VI.

TABLE VI
Co-Reactant (CR) Compositions

| | | Co-Reactant (CR) | | |
|---|---|---|---|---|
| | Brief Description | Composition (wt %) | | |
| Material | of Material | CR 1 | CR 2 | CR 3 |
| PE-PC-1 | polyester- | 35 | | |
| (from Synthesis Example 3) | polycarbonate polyol | | | |
| PE-PC-2 | polyester- | | 35 | |
| (from Synthesis Example 4) | polycarbonate polyol | | | |
| PE-PC-3 | polyester- | | | 35 |
| (from Synthesis Example 5) | polycarbonate polyol | | | |
| MODAFLOW ® | acrylic copolymer used | 0.25 | 0.25 | 0.25 |
| | as a flow modifier | | | |
| Ethyl acetate | used as a solvent | 64.75 | 64.75 | 64.75 |

### Adhesive Formulations

### Examples 1-3 and Comparative Example A

### General Procedure for Preparing an Adhesive Formulation

The adhesive formulations described in Table VII are prepared by mixing the components listed in Table VII under the following conditions:

The pertinent ingredients for preparing the adhesive formulations, the isocyanate-reactive component, and the isocyanate component are described in Table VII. Using the adhesive of Inventive Example 1 as an illustration for an adhesive formulation sample preparation, about 2,541 g of isocyanate-reactive component (Component B), about 459 g of isocyanate component (Component A) are loaded into a plastic container. The materials are mixed using a mechanical mixer at room temperature (about 25° C.) for 30 min to obtain the formulated adhesive of Inventive Example 1.

Table VII describes the adhesive formulations of selected examples wherein all the adhesives have the same amount of excess isocyanates.

TABLE VII
Adhesive Formulations

| | Formulation (wt % basis) | | | |
|---|---|---|---|---|
| Ingredient | Inv. Ex. 1 | Inv. Ex. 2 | Inv. Ex. 3 | Comp. Ex. A |
| CR 1 | 84.7 | | | |
| CR 2 | | 84.7 | | |
| CR 3 | | | 84.7 | |
| MOR-FREE ™ C33 | 15.3 | 15.3 | 15.3 | |
| ADCOTE ™ 577 | | | | 55 |
| ADCOTE ™ 577B | | | | 4.9 |
| Ethyl Acetate | | | | 40.1 |

### Coated Laminates

### Examples 4-6 and Comparative Example B

### General Procedure for Preparing a Coated Laminate

The polyurethane adhesive formulations of Inv. Ex. 1-3 and Comp. Ex. A are prepared as described above using the general procedure for preparing an adhesive formulation and using the formulation ingredients described in Table VII. Then, the adhesive formulations are first coated on a primary substrate via gravure cylinder. The coated films are then passed through a three zoned oven to dry the coated film and remove the ethyl acetate solvent. The coated films are then nipped to another substrate under a heated steel roll with a temperature of 90° C., and a nip pressure set to 40 PSI (275.8 kPa). The laminated structures are then placed in a temperature control room to cure at 23° C. for 7 days and 50% relative humidity (RH). The adhesive coating weight on each of the laminates is then measured and recorded.

### Examples 4-6

Coated laminates were produced using the polyurethane adhesive compositions of Inv. Ex. 1-3 described above in Table VII and using the general procedure for preparing a coated laminate as described above. Each of the resultant laminates of Inv. Ex. 4 - 6 had an adhesive coating weight of 3.5 g/m².

### Comparative Example B

In this Comp. Ex. B, a coated laminate was produced using the polyurethane adhesive formulation of Comp. Ex. A described above in Table VII and using the same general procedure for preparing a coated laminate as described above except that the coated laminate was placed in a temperature control room to cure at 23° C. for 7 days and 50% RH. The resultant laminate of

Comp. Ex. B had an adhesive coating weight of 3.5 g/m².

### Laminate/Adhesive Performance

The following tests: a 90° T-peel test and an oxygen transmission rate (OTR) measurement, were carried out using the coated laminate samples prepared above. The results of the tests are described in Table VIII.

### 90° T-Peel Test

A 90° T-peel test was done on laminate samples consisting of two films: a primary film and a secondary film adhered together with an adhesive. The laminate samples were cut to 15 mm wide strips and each of the samples were pulled on a Thwing Albert™ QC-3A peel tester equipped with a 50 N loading cell. The laminate samples were pulled with the peel tester at a rate of 4 in/min (10 cm/min) on the 15 mm strips. When the two films in the laminate separated (peeled), the average of the force during the pull was recorded. If one of the films stretched or broke, the maximum force or force at break was recorded. The final value for the laminate sample is the average value of three separate sample strips tested. The failure mode (FM) or mode of failure (MOF) was recorded as follows: AS (Adhesive Split) or cohesive failure which indicates that adhesive is found on both the primary and the secondary film.

### Oxygen Transmission Rate (OTR) Measurements

An oxygen transmission rate (OTR) of the formed laminate was measured using a MOCON OXTRAN 2/21 following the procedure described in ASTM method D3985 (“Standard Test Method for Oxygen Gas Transmission Rate through a Plastic Film and Sheeting Using a Coulometric Sensor”). The OTR data is reported in the standard unit “cc/(m²-day)”. The conditions used for testing to obtain OTR measurements were 23° C. and 85% relative humidity (RH).

TABLE VIII
Laminate Performance Measurements

| | | OTR | Bond Strength |
|---|---|---|---|
| Example No. | Sample Description | (cc/[m² - day]) | (N/15 mm) |
| Inv. Ex. 4 | Laminate coated with a PU adhesive based on | 201 | 0.7 (AS) |
| | crystalline polyester-polycarbonate (PE-PC-1) | | |
| Inv. Ex. 5 | Laminate coated with a PU adhesive based on | 462 | 2.7 (FT) |
| | crystalline polyester-polycarbonate (PE-PC-2) | | |
| Inv. Ex. 6 | Laminate coated with a PU adhesive based on | 561 | 0.8 (AS) |
| | crystalline polyester-polycarbonate (PE-PC-3) | | |
| Comp. Ex. B | Laminate coated with a PU adhesive based on a | 901 | 1.2 (AS) |
| | non-crystalline polyester | | |

From the data described in Table VIII, it can be seen that the laminates of Inv. Ex. 4, 5 and 6 coated with the adhesive formulations of Inv. Ex. 1, 2 and 3, respectively, containing a crystalline polyester-polycarbonate showed improved OTR barrier performance versus the laminates of Comp. Ex. B coated with an adhesive formulation (Comp. Ex. A) containing a non-crystalline polyester backbone.

What is claimed is:

1. A polyurethane adhesive composition based on a crystalline polyester-polycarbonate for producing an adhesive laminate structure comprising:
(a) at least one isocyanate component; and
(b) at least one isocyanate-reactive component comprising a blend of:
(bi) at least one crystalline polyester-polycarbonate diol compound;
(bii) at least one acrylic polymer compound; and
(biii) at least one solvent.

2. The adhesive composition of claim 1, wherein the weight ratio of component (a) to component (b) is from 4:100 to 30:100.

3. The adhesive composition of claim 1, wherein the crystalline polyester-polycarbonate compound is the reaction product of:
(bi) at least one polyester polyol precursor; and
(bii) at least one polycarbonate polyol precursor.

4. The adhesive composition of claim 3, wherein the polyester polyol precursor is selected from the group consisting of polyester resins based on ethylene glycol, diethylene glycol, 1,4- butanediol, 1,6-hexanediol, adipic acid, azelaic acid, sebacic acid, terephthalic acid, and combinations thereof.

5. The adhesive composition of claim 3, wherein the polycarbonate polyol precursor is selected from the group consisting of polycarbonate resins based on ethylene glycol, diethylene glycol, 1,4-butanediol, 1,6-hexanediol, 1,4-cyclohexanedimentanol, alkylene carbonates, diaryl carbonates, dialkyl carbonate, and combinations thereof.

6. The adhesive composition of claim 1, wherein the at least one isocyanate component is selected from the group consisting of xylylene diisocyanate-based polyisocyanates;
hexamethylene diisocyanate-based polyisocyanates; diphenylmethane diisocyanate-based polyisocyanates; toluene diisocyanate-based polyisocyanates; and mixtures thereof.

7. The adhesive composition of claim 1, wherein the at least one crystalline polyester-polycarbonate compound is selected from the group consisting of: (1) the reaction product of poly(1,4-butanediol-adipic acid) and poly(1,4-butanediol-dimethyl carbonate); (2) the reaction product of poly(1,6-hexanediol-adipic acid) and poly(1,4-butanediol-dimethyl carbonate); and
(3) mixtures thereof.

8. The adhesive composition of claim 1, wherein the at least one acrylic polymer compound comprises polylauryl acrylate, polybutyl acrylate, poly(2-ethylhexyl) acrylate, poly(ethylacrylate-2-ethylhexylacrylate), polylauryl methacrylate, acrylic copolymer made of two or more monomers, including methyl acrylate, ethyl acrylate, butyl acrylate, 2-ethylhexyl acrylate, lauryl acrylate, methyl methacrylate, acrylic acid, methacrylic acid, styrene, vinyl acetate, butadiene and mixtures thereof.

9. The adhesive composition of claim 1, wherein the wherein the at least one solvent is ethyl acetate, methyl ethyl ketone, and mixtures thereof.

10. The adhesive composition of claim 1, wherein adhesive composition is used to form a laminate having an oxygen transmission rate of less than 750 cubic centimeters per [square meter−day].

11. A process for producing a polyurethane adhesive composition based on crystalline polyester-polycarbonate for producing an adhesive laminate structure comprising admixing:
(a) at least one isocyanate component; and
(b) at least one isocyanate-reactive component comprising a blend of
(bi) at least one crystalline polyester-polycarbonate diol compound;
(bii) at least one acrylic polymer compound; and
(biii) at least one solvent.

12. A multi-layer laminate product comprising:
(A) at least a first layer;
(B) at least a second layer; and
(C) at least one layer of cured adhesive of claim 1 disposed inbetween the first layer and the second layer; wherein the cured adhesive bonds the first layer to the second layer; and
provides a laminate having an oxygen transmission rate (OTR) of less than 750 cubic centimeters per [square meter−day].

13. A process for producing a multi-layer laminate product comprising the steps of:
(I) applying the adhesive of claim 1 to at least a portion of the surface of a first layer and/or a second layer;
(II) contacting the first layer and the second layer such that the adhesive is disposed inbetween the first layer and the second layer; and
(III) curing the adhesive to form a multi-layer laminate product comprising the first layer bonded to the second layer via the cured adhesive.

14. A packaging container article comprising the laminate of claim 12.
